(19) United States
(12) Patent Application Publication
(10) Pub. No.: US 2011/0045367 A1
(43) Pub. Date: Feb. 24, 2011

(54) Fuel Cell Supply System, Fuel Cell System and Method of Operating the Same

(75) Inventor: Hans-Joerg Heidrich, Ulm (DE)

Correspondence Address: CROWELL & MORING LLP;INTELLECTUAL PROPERTY GROUP, P.O. BOX 14300, WASHINGTON, DC, 20044-4300, US

(73) Assignees: DAIMLER AG, STUTTGART (DE); FORD GLOBAL TECHNOLOGIES, LLC, DEARBORN, MI (US)

(21) Appl. No.: 12/867,428

(22) PCT Filed: Feb. 4, 2009
(86) PCT No.: PCT/EP09/00735

§ 371 Date: Oct. 29, 2010

(30) Foreign Application Priority Data
Feb. 13, 2008 (DE) 10 2008 008 870.6

(51) Int. Cl. H01M 8/06

(52) U.S. Cl. 429/413

(57) ABSTRACT

A fuel cell supply system 6 is proposed for feeding an oxidizing agent to a fuel cell assembly 2, has a continuous flow machine for accelerating and/or increasing the pressure of the oxidizing agent, and a humidifier for humidifying the oxidizing agent. The humidifier is connected or connectable flow-wise between the continuous flow machine and the fuel cell assembly, and has a dehumidifier, which is designed and/or arranged to dehumidify the oxidizing agent.

This application is a national stage of PCT International Application No. PCT/EP2009/000735, filed Feb. 4, 2009, which claims priority under 35 U.S.C. §119 to German Patent Application No. 10 2008 008 870.6, filed Feb. 13, 2008, the entire disclosure of which is herein expressly incorporated by reference.

### BACKGROUND AND SUMMARY OF THE INVENTION

The present invention relates to a fuel cell supply system for feeding an oxidizing agent to a fuel cell assembly, with a continuous flow machine for accelerating and/or increasing the pressure of the oxidizing agent, and a humidifier for humidifying the oxidizing agent. The humidifier is connected and/or connectable flow-wise between the continuous flow machine and the fuel cell assembly. The invention further relates to a fuel cell device having the fuel cell supply system, and to a method for operation thereof.

Fuel cell systems may be used as energy generators for generating the drive energy for vehicles. Fuel cell systems implement an electrochemical process, wherein a fuel, generally hydrogen, is reacted with an oxidizing agent, generally ambient air or oxygen, chemical energy being converted into electrical energy.

A proton-conducting membrane arranged in fuel cell systems between the anode and cathode areas plays a decisive part in energy conversion. This membrane is a component of fuel cell systems which is susceptible to wear. When fuel cell systems are in operation, care must be taken to ensure that this membrane does not dry out, since premature wear is accelerated thereby. For this reason it is conventional for the oxidizing agent supply systems of fuel cell systems to comprise a device for humidifying the oxidizing agent supplied. While such humidification of the oxidizing agent can be controlled sufficiently precisely during steady-state operation, starting and shutdown of the fuel cell system represent a particular challenge.

U.S. Pat. No. 7,141,326 B2 relates to a fuel cell system with a warm-up apparatus for a fuel cell, the problem of starting the fuel cell system being specifically addressed. The document proposes firstly to compress ambient air by means of a compressor, then to cool it by means of an intercooler, humidify it and finally feed it to the fuel cell. To achieve quick warming up of the fuel cell system, the document on the one hand discloses providing a bypass for the intercooler, which bypass is activated in particular when operation is started in order to introduce the oxidizing agent into the fuel cell at a high temperature. It is further proposed to integrate a heat exchanger between the oxidizing agent feed and the fuel feed, such that thermal energy is released from the oxidizing agent to the fuel, in order to avoid an excessive temperature differential between the cathode area and the anode area.

One object of the invention is to provide a fuel cell supply system for feeding an oxidizing agent to a fuel cell assembly which allows an operationally reliable, low-wear start or switch-off procedure for the fuel cell assembly.

This and other objects and advantages are achieved by the fuel cell supply system according to the invention, which is suitable and/or designed for feeding an oxidizing agent (preferably ambient air and/or oxygen) to a fuel cell assembly. The fuel cell assembly comprises at least one fuel cell having a cathode area, an anode area and a membrane, in particular a PEM (Proton Exchange Membrane).

The fuel cell supply system according to the invention comprises a continuous flow machine, which is designed and/or arranged to accelerate and/or increase the pressure of the oxidizing agent. The continuous flow machine preferably takes the form of a compressor, in particular a screw compressor.

In addition, the fuel cell supply system comprises a humidifier, which humidifies the oxidizing agent (i.e., increases its moisture content by supplying water). The moisture content is preferably understood to mean a characteristic parameter for the quotient obtained by dividing the liquid or water quantity in a specific quantity or mass of oxidizing agent by this oxidizing agent quantity or mass.

The humidifier is connected and/or connectable (in particular, temporarily connectable), flow-wise, between the continuous flow machine and the fuel cell assembly, the accelerated and/or increased-pressure oxidizing agent being humidified. The humidifier may be of any desired construction, for example it may take the form of an absorption/desorption device, which removes moisture from the moist cathode waste air or from the anode circuit. However, the humidifier may also take the moisture to be supplied from a storage tank.

According to the invention it is proposed to integrate a dehumidifier into the fuel cell supply system, which is designed and/or arranged to dehumidify the oxidizing agent, in particular the oxidizing agent to be fed to the fuel cell assembly.

It is a consideration of the invention that, for optimum operation, the moisture content of the oxidizing agent fed to the fuel cell assembly should not always be constant but rather adjusted as a function of the operating state. For example, it is advisable to adjust the moisture content as a function of current load (that is, to select different moisture contents for partial or full load). This may be achieved by the invention.

It is a further consideration of the invention that the dew point for the humidified oxidizing agent be reduced by reducing the moisture content in the oxidizing agent, so as to avoid problems caused in the event of a sub-freezing start by condensation and freezing of moisture in the fuel cell assembly. Otherwise there could be a risk of the gas pathways freezing up, so partially or wholly preventing further supply of the fuel cell assembly with reaction gases. In addition it is desirable and possible in certain embodiments of the invention to dry the fuel cell assembly internally when the system is switched off, such that, after switch-off of the fuel cell assembly, little or no undesired moisture remains.

Since humidifiers are sometimes difficult to control, it is proposed to integrate a dehumidifier, which dehumidifies the oxidizing agent, in particular as a function of control signals. It may optionally be provided that initially the humidifier is throttled or the action of the humidifier is minimized, for example by means of a bypass line around the humidifier, and the dehumidifier is only connected if a further reduction in moisture content is necessary.

It is particularly preferable for the dehumidifier to be arranged flow-wise after the humidifier (that is, downstream between the humidifier and the fuel cell assembly). In this position the oxidizing agent has its maximum moisture content, such that the dehumidifier may be very effective.

In a preferred embodiment of the invention the dehumidifier is of connectable construction. In one possible alternative the dehumidifier may be connected by activation. In another alternative the dehumidifier is connected flow-wise, for example the dehumidifier is arranged in a connectable branch of the fuel cell supply system, which may be connected by a valve or the like.

In another embodiment of the invention the dehumidifier is integrated into the humidifier and/or coupled directly with the humidifier. This embodiment of the invention is directed towards preventing the oxidizing agent from taking up moisture in the humidifier. In this case, the dehumidifier is arranged parallel to the humidifier, such that the two devices are arranged for mass and/or heat transfer. Thus, the dehumidifier reduces the humidifying action of the humidifier, such that the oxidizing agent has a lower moisture content downstream of the (de-)humidifier.

In a further development of the invention the fuel cell supply system comprises a cooling device, which is arranged flow-wise after the continuous flow machine, but before the dehumidifier. The cooling device takes the form, for example, of a cryostat or heat exchanger. By activating the cooling device, the temperature of the oxidizing agent is reduced, such that the relative or absolute humidity (that is, the quotient obtained by dividing a quantity of liquid or water in a specific volume of oxidizing agent by the volume) increases and the downstream dehumidifier is more efficient. The cooling device may optionally be provided separately from an intercooler and/or a charge air cooler.

In a possible alternative embodiment the cooling device is arranged before the humidifier, such that the total take-up of moisture in the humidifier is minimized by cooling of the oxidizing agent. In a modified embodiment the cooling device is positioned only after the humidifier.

In a possible structural embodiment of the invention, the dehumidifier takes the form of a humidity buffer, which preferably temporarily stores moisture and releases it again at a later point in the fuel cell supply system. Thus, the dehumidifier forms a temporary sink, a storage means or a cold trap.

In another structural embodiment the dehumidifier takes the form of a drying device, which diverts the moisture removed from the oxidizing agent and outputs it for example into the environment.

Provision may in this respect be made for the dehumidifier to take the form of a passive device, acting for example chemically or physically. In other embodiments the dehumidifier is driven by external energy, for example electrical energy or mechanical energy.

In one possible embodiment the dehumidifier takes the form of a membrane dryer, an enthalpy wheel, a chemical reactor (in particular a water-consuming reactor), an absorber and/or an adsorber. Such an enthalpy wheel is known for example from Published U.S. Patent Application No. 2002/0050145 Al or U.S. Pat. No. 6,013,385 A, the disclosure of which is incorporated by reference into the present application.

In a preferred embodiment the fuel cell supply system comprises a control device, which is designed for open- or closed-loop control of the dehumidifier and/or of the cooling device, in particular additional cooling capacity, being activated in the event of system switch-off or of cold starting, in particular sub-freezing starting, of the fuel cell assembly.

The present invention also provides a fuel cell device for mobile use, which has a plurality of fuel cells (in particular more than 100, and especially more than 150 fuel cells), and is suitable and/or designed in particular for a vehicle. The fuel cell device also has a fuel cell supply system, as described above.

The invention finally relates to a method for switching off and/or cold starting a fuel cell device in particular for sub-freezing starting thereof. Water-extracting measures are applied to the oxidizing agent. A cold start preferably takes place at temperatures below 20° C., preferably below 10° C. and in particular below 0° C.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a fuel cell supply system as a first exemplary embodiment of the invention;

FIG. 2 is a block diagram of a fuel cell supply system as a second exemplary embodiment of the invention;

FIG. 3 is a block diagram of a fuel cell supply system as a third exemplary embodiment of the invention;

FIG. 4 is a block diagram of a fuel cell supply system as a fourth exemplary embodiment of the invention; and

FIG. 5 is a block diagram of a fuel cell supply system as a fifth exemplary embodiment of the invention.

### DETAILED DESCRIPTION OF THE DRAWINGS

Parts which are identical or correspond to one another are in each case provided with identical or mutually corresponding reference numerals. Optional parts are shown with broken lines.

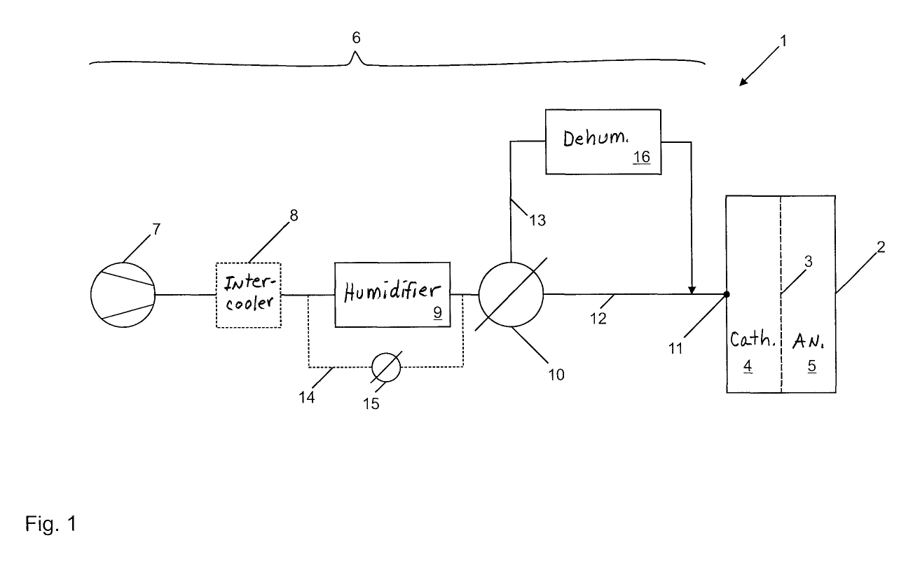

FIG. 1 is a highly schematic representation of a fuel cell device 1 for mobile use, for example for generating energy for the drive train of a vehicle.

The fuel cell device 1 comprises a fuel cell assembly 2, which consists of a plurality of fuel cells, (FIG. 1 showing a schematic representation of just one fuel cell with a membrane 3 separating a cathode area 4 from an anode area 5). To supply the cathode area 4 with an oxidizing agent, e.g., ambient air, the fuel cell device 1 has a fuel cell supply system 6 with a continuous flow machine 7 in the form, for example, of a compressor, in particular of a radial compressor. An intercooler 8, also known as a charge air cooler, is optionally connected downstream of the continuous flow machine 7, which intercooler 8 brings the oxidizing agent compressed by the continuous flow machine 7 to a desired operating temperature, in particular cools it. For example, the intercooler 8 is connected to a cooling circuit of the fuel cell device 1.

In order to achieve satisfactory humidification of the compressed oxidizing agent, the fuel cell supply system 6 comprises a humidifier 9. The humidifier 9 may be of any desired construction, for example it may take the form of a coupling element coupled to an outlet of the cathode area 5, so as to pump moisture from the cathode waste air into the oxidizing agent feed by means of absorption/desorption.

In normal continuous operation, in particular under full load, the compressed and humidified oxidizing agent is passed from a valve device 10 to an inlet 11 of the cathode area 4. The valve device 10 may on the one hand take the form of a three-way valve, which subdivides the oxidizing agent stream into two sub-streams, namely into a main line 12 and a branch line 13. As an alternative, the valve device may also take the form of a shut-off valve in the main line 12 or in the branch line 13, in order to distribute the oxidizing agent stream. A bypass line 14 with a shut-off valve 15 may optionally additionally be provided around the humidifier 9.

The branch line 13 leads via a dehumidifier 16, which extracts moisture from the compressed and humidified oxidizing agent. (That is, it reduces the moisture content.) The dehumidifier 16 may take the form of a temporary dehumidifier, which intermediately stores the moisture in the manner of a buffer, or a permanent dehumidifier, which discharges the extracted moisture out of the fuel cell supply system 6. Once it has flowed through the dehumidifier 16, the dehumidified oxidizing agent is passed to the cathode area inlet 11.

When in operation, the fuel cell supply system 6 can be controlled in such a way that in special operating states (in particular on system startup or on system switch-off of the fuel cell device 1), dehumidified oxidizing agent passes into the cathode area 4. This is achieved by reducing the humidifying capacity of the humidifier 9 for example by using the bypass line 14 or by directly limiting the humidifier 9. The oxidizing agent which is then not humidified (or only slightly humidified) is then guided via the valve device 10 into the branch line 13 and flows through the dehumidifier 16, so as further to reduce the moisture content. The dehumidified oxidizing agent finally passes into the cathode inlet 11.

This procedure is used particularly advantageously in the event of a sub-freezing start, since as a result of the dehumidification of the oxidizing agent the dew point of the oxidizing agent is reduced and condensation in the cold cathode area 4 and possible freezing up of the gas pathways is avoided. In this way, even in the event of a sub-freezing start, (i.e., in particular at temperatures of the fuel cell assembly 2 of below 0° C.), more reliable system startup of the fuel cell device 1 is possible.

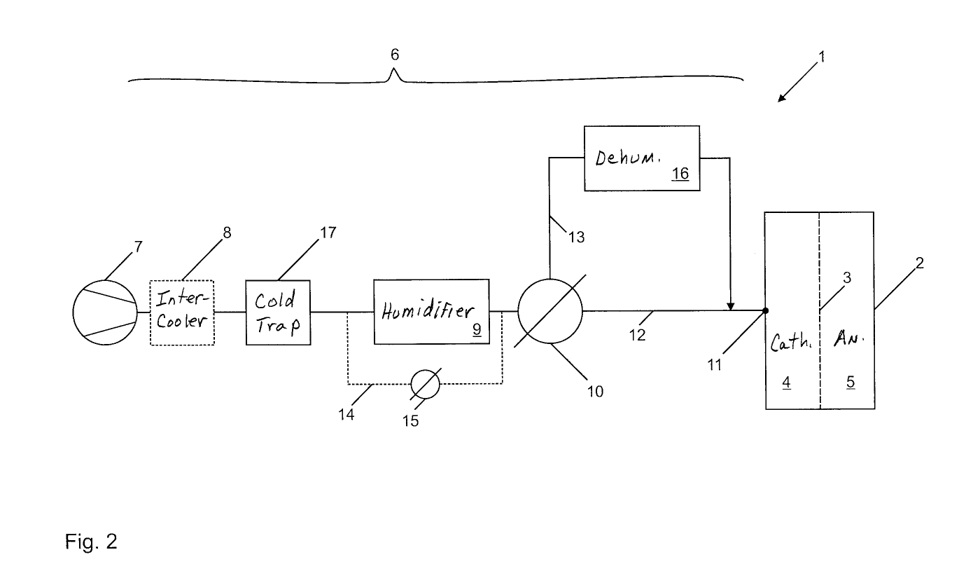

FIG. 2 shows a second exemplary embodiment of the fuel cell supply system 6. In comparison with the first exemplary embodiment in FIG. 1, the fuel cell supply system 6 in FIG. 2 additionally comprises a cooling device 17, which is connected flow-wise before the humidifier 9. As a result of the additional cooling device 17 connected in particular after the optional intercooler 8, in the event of system startup, system switch-off or a sub-freezing start the compressed oxidizing agent is also cooled, so as to reduce moisture take-up in the humidifier 9. As an alternative to the cooling device 17, the intercooler 8 may also be actuated in such a way as to increase its cooling capacity. Preferably the oxidizing agent is cooled to temperatures of below 50° C., in particular below 30° C.

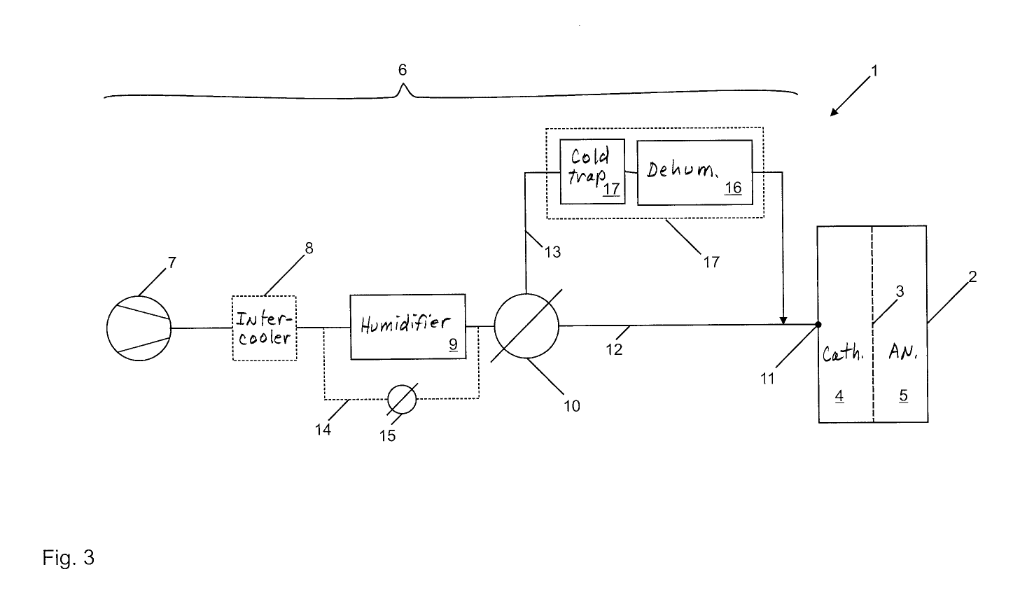

FIG. 3 shows a third exemplary embodiment of the invention, which differs from the first exemplary embodiment of the invention in that the cooling device 17 is arranged in the branch line 13 before the dehumidifier 16. To dry the oxidizing agent it is proposed in this exemplary embodiment to cool the humidified or only slightly humidified oxidizing agent actively, in order to increase the relative humidity thereof, such that the dehumidifier 16 may work more effectively. In modified embodiments the dehumidifier 16 and the cooling device 17 may also jointly form a cold trap 17.

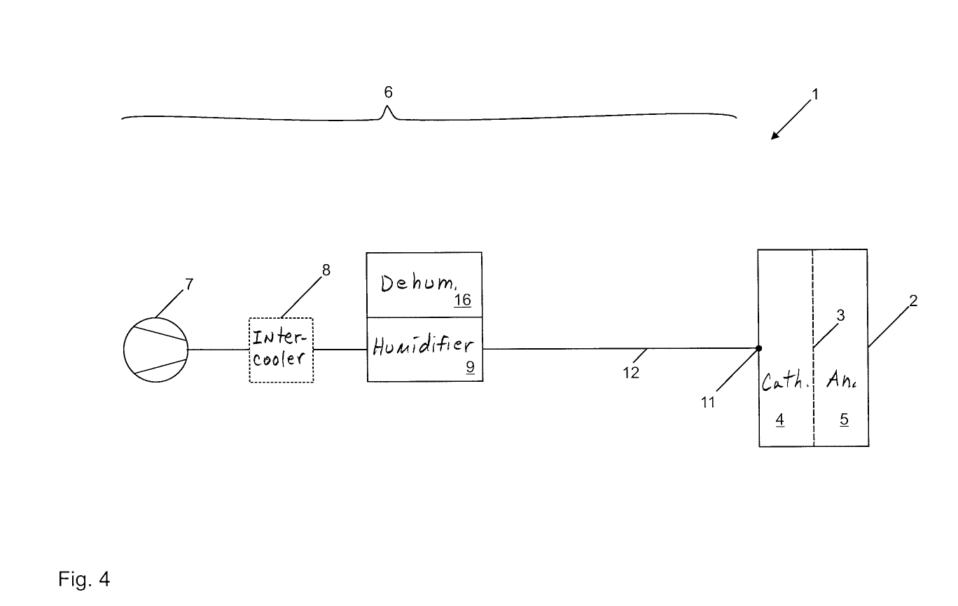

FIG. 4 shows a fourth exemplary embodiment of the invention in similar representation, wherein, in comparison to the preceding exemplary embodiments, the dehumidifier 16 is positioned directly on the humidifier 9 or is arranged parallel thereto. In this exemplary embodiment, the dehumidifier and humidifier 16 and 9 respectively are arranged for mass and/or heat transfer, wherein the dehumidifier 16 reduces or compensates the humidifying action of the humidifier 9, such that no or only a small amount of moisture is introduced by the humidifier 9 into the oxidizing agent. By activating the dehumidifier 16, the humidity in the oxidizing agent is kept low and the dew point of the oxidizing agent fed to the fuel cell assembly 2 is quickly reduced.

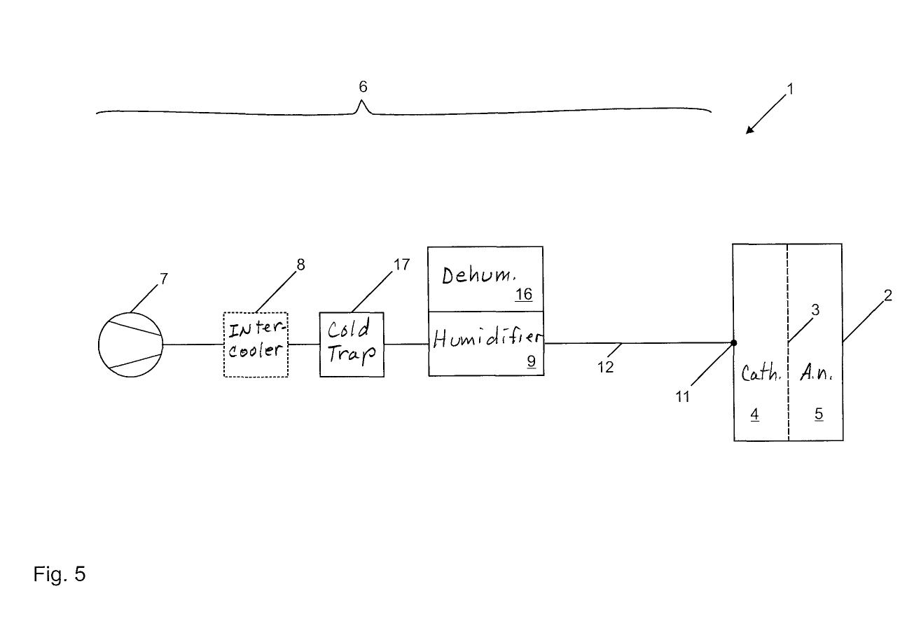

FIG. 5 shows a last exemplary embodiment of the invention, in which an additional cooling device 17 is connected upstream of the combined humidifier/dehumidifier 9, 16, so as to reduce the moisture take-up capacity of the oxidizing agent by cooling.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

1 Fuel cell device
2 Fuel cell assembly
3 Membrane
4 Cathode area
5 Anode area
6 Fuel cell supply system
7 Continuous flow machine
8 Intercooler
9 Humidifier
10 Valve device
11 Cathode area inlet
12 Main line
13 Branch line
14 Bypass line
15 Shut-off valve
16 Dehumidifier
17 Cooling device, cold trap

1-14. (canceled)

15. A fuel cell supply system (6) for feeding an oxidizing agent to a fuel cell assembly having a continuous flow machine for accelerating and/or increasing the pressure of the oxidizing agent and having a humidifier for humidifying the oxidizing agent, the humidifier being connected or connectable flow-wise between the continuous flow machine and the fuel cell assembly, a dehumidifier, which is designed or arranged for dehumidification of the oxidizing agent.

16. The fuel cell supply system as claimed in claim 15, wherein the dehumidifier is arranged flow-wise downstream of the humidifier.

17. The fuel cell supply system as claimed in claim 16, wherein the dehumidifier is of connectable construction.

18. The fuel cell supply system as claimed in claim 17, wherein the dehumidifier may be connected by division of the oxidizing agent into sub-streams.

19. The fuel cell supply system as claimed in claim 15, wherein the dehumidifier is one of integrated into the humidifier and coupled directly to the humidifier.

20. The fuel cell supply system as claimed in claim 15, further comprising a cooling device, which is arranged flow-wise after the continuous flow machine and before the dehumidifier.

21. The fuel cell supply system as claimed in claim 20, wherein the cooling device is arranged flow-wise after the humidifier.

22. The fuel cell supply system as claimed in claim 15, wherein the dehumidifier is a humidity buffer.

23. The fuel cell supply system as claimed in claim 1, wherein the dehumidifier takes the form of a humidity diverter.

24. The fuel cell supply system as claimed in claim 15, wherein the dehumidifier takes the form of a passive device or a device operated by external energy.

25. The fuel cell supply system as claimed in claim 15, wherein the dehumidifier comprises one of a membrane dryer, an enthalpy wheel, a chemical reactor, an absorber and an adsorber.

26. The fuel cell supply system as claimed in claim 15, further comprising a control device to activate the dehumidifier and/or the cooling device in the event of system switch-off or of a cold start of the fuel cell device.

27. A fuel cell device for a vehicle, having a fuel cell supply system as claimed in claim 15.

28. A method of switching off and/or cold starting the fuel cell device as claimed in claim 27, wherein water-extracting measures are applied to the oxidizing agent.
